(19) United States
(12) Patent Application Publication
(10) Pub. No.: US 2023/0300012 A1
(43) Pub. Date: Sep. 21, 2023

(54) METHOD AND APPARATUS FOR AN SRS PROCEDURE

(71) Applicant: Samsung Electronics Co., Ltd., Suwon-si (KR)

(72) Inventors: Gilwon Lee, McKinney, TX (US); Md. Saifur Rahman, Plano, TX (US); Eko Onggosanusi, Coppell, TX (US)

(21) Appl. No.: 18/179,277

(22) Filed: Mar. 6, 2023

Related U.S. Application Data
(60) Provisional application No. 63/320,529, filed on Mar. 16, 2022.

(51) Int. Cl. H04L 27/26; H04L 5/00

(52) U.S. Cl. CPC H04L 27/261; H04L 5/0048; H04L 27/2607

(57) ABSTRACT

Apparatuses and methods for sounding reference signal (SRS) procedures. A method performed by a user equipment (UE) includes receiving a configuration about transmission on a sounding reference signal (SRS) resource. The configuration includes information about 8 transmit antenna ports partitioned into X antenna groups. Each of the X antenna groups includes respective 8/X antenna ports. Each of the X antenna groups is associated with a respective transmission comb offset and each of the respective 8/X antenna ports within a group of the X antenna groups is associated with a respective cyclic shift, or each of the X antenna groups is associated with a respective cyclic shift and each of the respective 8/X antenna ports within the group of the X antenna groups is associated with a respective transmission comb offset. The method further includes transmitting, based on the configuration, on the SRS resource via the 8 transmit antenna ports.

### CROSS-REFERENCE TO RELATED APPLICATION AND CLAIM OF PRIORITY

This application claims priority under 35 U.S.C. § 119(e) to U.S. Provisional Patent Application No. 63/320,529 filed on Mar. 16, 2022. The above-identified provisional patent application is hereby incorporated by reference in its entirety.

### TECHNICAL FIELD

The present disclosure relates generally to wireless communication systems and, more specifically, to sounding reference signal (SRS) procedures and enhancement.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to apparatuses and methods for SRS procedures and enhancement.

In one embodiment, a user equipment (UE) is provided. The UE includes a transceiver configured to receive a configuration about transmission on a sounding reference signal (SRS) resource and a processor operably coupled to the transceiver, The processor is configured to identify, based on the configuration, information about 8 transmit antenna ports partitioned into X antenna groups. Each of the X antenna groups includes respective 8/X antenna ports. Each of the X antenna groups is associated with a respective transmission comb offset and each of the respective 8/X antenna ports within a group of the X antenna groups is associated with a respective cyclic shift, or each of the X antenna groups is associated with a respective cyclic shift and each of the respective 8/X antenna ports within the group of the X antenna groups is associated with a respective transmission comb offset. The transceiver is further configured to transmit, based on the configuration, on the SRS resource via the 8 transmit antenna ports.

In another embodiment, a base station (BS) is provided. The BS includes a processor configured to generate a configuration about transmission on a SRS resource. The configuration includes information about 8 transmit antenna ports partitioned into X antenna groups. Each of the X antenna groups includes respective 8/X antenna ports. Each of the X antenna groups is associated with a respective transmission comb offset and each of the respective 8/X antenna ports within a group of the X antenna groups is associated with a respective cyclic shift, or each of the X antenna groups is associated with a respective cyclic shift and each of the respective 8/X antenna ports within the group of the X antenna groups is associated with a respective transmission comb offset. The BS further includes a transceiver operably coupled to the processor. The transceiver is configured to transmit the configuration and receive, based on the configuration, on the SRS resource.

In yet another embodiment, a method performed by a UE is provided. The method includes receiving a configuration about transmission on a SRS resource. The configuration includes information about 8 transmit antenna ports partitioned into X antenna groups. Each of the X antenna groups includes respective 8/X antenna ports. Each of the X antenna groups is associated with a respective transmission comb offset and each of the respective 8/X antenna ports within a group of the X antenna groups is associated with a respective cyclic shift, or each of the X antenna groups is associated with a respective cyclic shift and each of the respective 8/X antenna ports within the group of the X antenna groups is associated with a respective transmission comb offset. The method further includes transmitting, based on the configuration, on the SRS resource via the 8 transmit antenna ports.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIG. 4 illustrates an example antenna blocks or arrays forming beams according to embodiments of the present disclosure; and

FIG. 5 illustrates a flowchart of an example method for an SRS procedure in a wireless communication system according to embodiments of the present disclosure.

### DETAILED DESCRIPTION

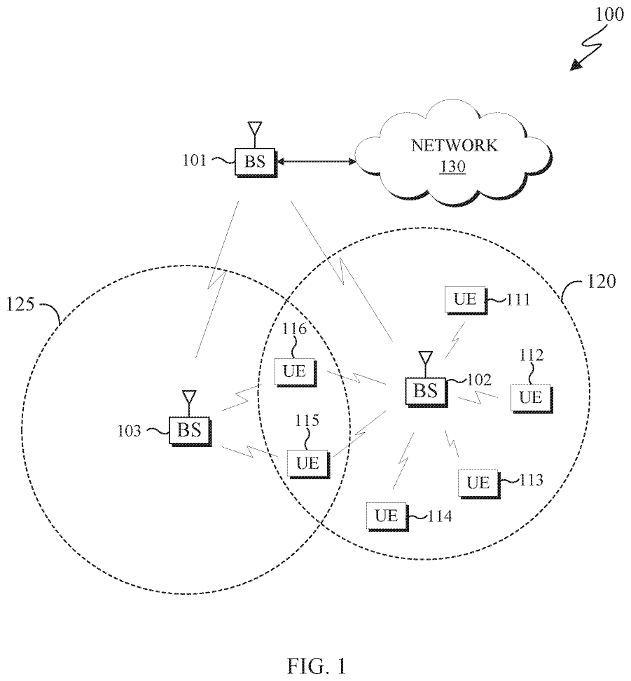

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 36.211 v17.0.0, “E-UTRA, Physical channels and modulation” (herein “REF 1”); 3GPP TS 36.212 v17.0.0, “E-UTRA, Multiplexing and Channel coding” (herein “REF 2”); 3GPP TS 36.213 v17.0.0, “E-UTRA, Physical Layer Procedures” (herein “REF 3”); 3GPP TS 36.321 v16.6.0, “E-UTRA, Medium Access Control (MAC) protocol specification” (herein “REF 4”); 3GPP TS 36.331 v16.7.0, “E-UTRA, Radio Resource Control (RRC) protocol specification” (herein “REF 5”); 3GPP TS 38.211 v17.0.0, “NR, Physical Channels and Modulation” (herein “REF 6”); 3GPP TS 38.212 v17.0.0, “NR, Multiplexing and channel coding” (herein “REF 7”); 3GPP TS 38.213 v17.0.0, “NR, Physical Layer Procedures for Control” (herein “REF 8”); 3GPP TS 38.214 v17.0.0; “NR, Physical Layer Procedures for Data” (herein “REF 9”); 3GPP TS 38.215 v17.0.0; “NR, Physical Layer Measurements” (herein “REF 10”); 3GPP TS 38.321 v16.7.0; “NR, Medium Access Control (MAC) Protocol Specification” (herein “REF 11”); and 3GPP TS 38.331 v16.7.0; “NR, Radio Resource Control (RRC) Protocol Specification” (herein “REF 12”)

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for supporting SRS procedures and enhancement. In certain embodiments, one or more of the BS s 101-103 include circuitry, programing, or a combination thereof for supporting SRS procedures and enhancement.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

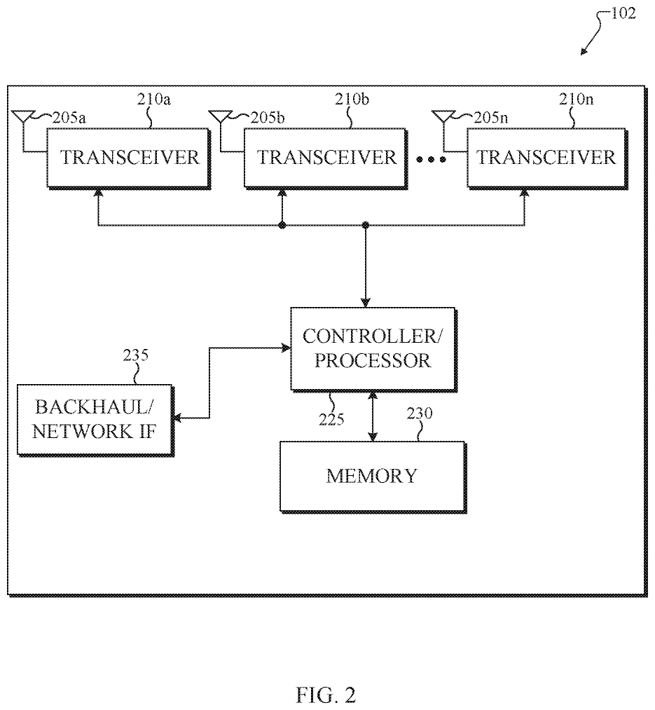

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting SRS procedures and enhancement. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

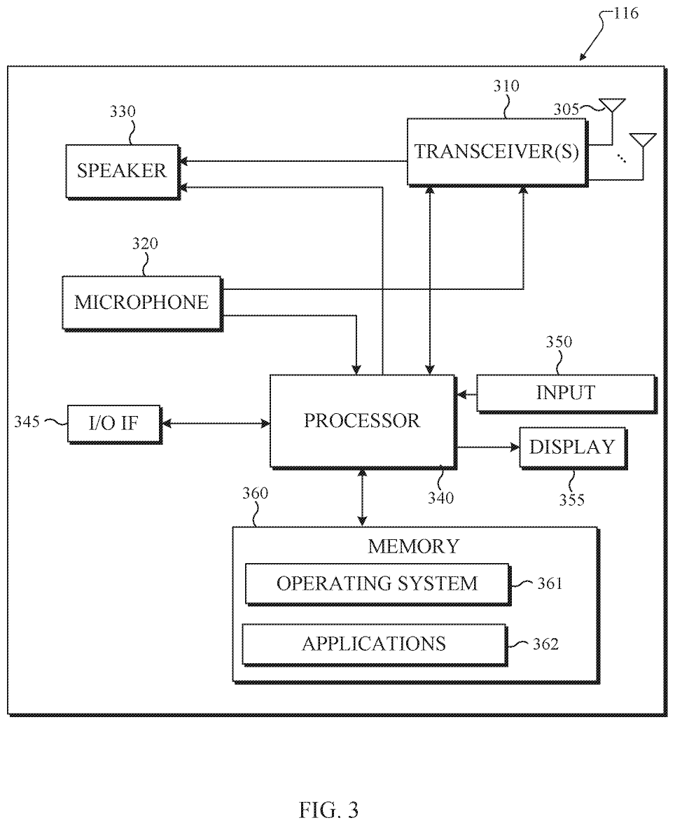

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for SRS procedures and enhancement. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

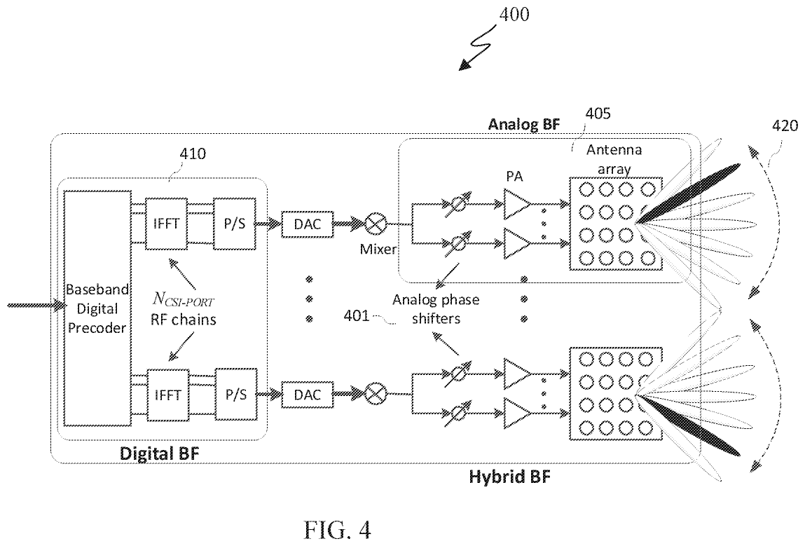

FIG. 4 illustrates an example antenna blocks or arrays 400 according to embodiments of the present disclosure. The embodiment of the antenna blocks or arrays 400 illustrated in FIG. 4 is for illustration only. FIG. 4 does not limit the scope of this disclosure to any particular implementation of the antenna blocks or arrays.

The 3GPP NR specification supports up to 32 CSI-RS antenna ports which enable a gNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies). In this case, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes. The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @100 m distance), larger number of and sharper analog beams (hence larger number of radiators in the array) will be needed to compensate for the additional path loss.

Various embodiments of the present disclosure provide an SRS resource for enabling 8 TX uplink operation based on two-domain components, frequency-domain (FD), and code-domain (CD) components. An SRS resource for uplink 8 TX transmission can be designed based on Rel-17 SRS resource (i.e., extension of Rel-17 SRS resource). Various embodiments of the present disclosure propose how an SRS resource is constructed to enable 8 TX UL operation by designing the SRS sequence across 8 SRS ports (i.e., the case of Nₐₚ^{SRS}=8) for the SRS resource. In order to support 8 TX UL operation, various embodiments of the present disclosure consider 3 cases with respect to combination of frequency/code domain components (except the case that all domain components are not used), wherein the corresponding components are associated with SRS ports.

In one embodiment, the sounding reference signal sequence for an SRS resource with 8 ports is generated using an FD component to multiplex the SRS resource across ports.

In one embodiment, the SRS sequence is generated using different transmission comb offsets across 8 antenna ports.

In one example, as described in Section 6.4.1.4.2 of [6], maximum number of cyclic shifts n_{SRS}^{CS,max} is determined as a function of K_{TC}, which is as follows:

| K_{TC} | n_{SRS}^{CS, max} |
|---|---|
| 2 | 8 |
| 4 | 12 |
| 8 | 6 |

In one example, when K_{TC}=8, where K_{TC} is the transmission comb number contained in the higher-layer parameter transmissionComb, each antenna port is associated with a different transmission comb offset k_{TC}^{(p}^{ᵢ}⁾, and thus the frequency-domain starting position k₀^{(p}^{ᵢ}⁾ is different across antenna ports (Section 6.4.1.4.3 in [6]).

In one example, when K_{TC}>8, where K_{TC} is the transmission comb number contained in the higher-layer parameter transmissionComb, each antenna port is associated with a different transmission comb offset k_{TC}^{(p}^{ᵢ}⁾, and thus the frequency-domain starting position k₀^{(p}^{ᵢ}⁾ is different across antenna ports (Section 6.4.1.4.3 in [6]).

In one example, K_{TC}=16 is newly added in the set for K_{TC} (currently, K_{TC}∈{2, 4, 8} is supported) and if it is configured in the higher-layer parameter transmissionComb, each antenna port is associated with a different transmission comb offset k_{TC}^{(p}^{ᵢ}⁾, and thus the frequency-domain starting position k₀^{(p}^{ᵢ}⁾ is different across antenna ports (Section 6.4.1.4.3 in [6]). In contrast with the case of K_{TC}=8, the case of K_{TC}=16 has several possible patterns for associating antenna ports with transmission comb offsets.
In one example, each even number (0, 2, 4, . . . , 14) of k_{TC}^{(p}^{ᵢ}⁾ is associated with each antenna port or each odd number (1, 3, 5, . . . , 15) of k_{TC}^{(p}^{ᵢ}⁾ is associated with each antenna port. In this case, an 1-bit parameter can be newly added to indicate one of the two cases (even number case or odd number case). For example, ‘0’ indicates that each even number (0, 2, 4, . . . , 14) of k_{TC}^{(p}^{ᵢ}⁾ is associated with each antenna port, and ‘1’ indicates that each odd number (1, 3, 5, . . . , 15) of k_{TC}^{(p}^{ᵢ}⁾ is associated with each antenna port.
In another example, the first eight numbers of k_{TC}^{(p}^{ᵢ}⁾ (i.e., 0 to 7) are associated with 8 antenna ports or the last eight numbers of k_{TC}^{(p}^{ᵢ}⁾ (i.e., 8 to 15) are associated with 8 antenna ports. In this case, an 1-bit parameter can be newly added to indicate one of the two cases (the case of the first 8 numbers or the case of the last 8 numbers). For example, ‘0’ indicates that the first eight numbers of k_{TC}^{(p}^{ᵢ}⁾ (i.e., 0 to 7) are associated with 8 antenna ports, and ‘1’ indicates that the last eight numbers of k_{TC}^{(p}^{ᵢ}⁾ (i.e., 8 to 15) are associated with 8 antenna ports.

In one embodiment, the SRS sequence is generated using RB-level partial-frequency sounding parameters (e.g., P_{F}, k_{F} of Section 6.4.1.4.3 in [6]) across 8 antenna ports.

In one embodiment, the SRS sequence is generated using transmission comb offsets (e.g., K_{TC}, k_{TC}^{(p}^{ᵢ}⁾ of Section 6.4.1.4.3 in [6]) and RB-level partial-frequency sounding (RPFS) parameters (e.g., n_{offset}^{PPFS}, P_{F}, k_{F} of Section 6.4.1.4.3 in [6]) across 8 antenna ports.

In one example, the 8 antenna ports are partitioned into two groups each of which is associated with 4 antenna ports. Within each group, each antenna port is associated with a different transmission comb offset k_{TC}^{(p}^{ᵢ}⁾. Each group is associated with a different RPFS offset n_{offset}^{RPFS}, and a same set of transmission comb offsets.

In one example, when Nₐₚ^{SRS}=8, transmission comb offset k_{TC}^{(p}^{ᵢ}⁾ is given by

$${k}_{TC}^{( {p}_{i} )} = \{ \begin{matrix}( {\overline{k}}_{TC} + 3 {K}_{TC} / 4 ) mod {K}_{TC} , & {p}_{i} ∈ \{ 1003 , 1007 \} \\ ( {\overline{k}}_{TC} + {K}_{TC} / 2 ) mod {K}_{TC} , & {p}_{i} ∈ \{ 1002 , 1006 \} \\ ( {\overline{k}}_{TC} + {K}_{TC} / 4 ) mod {K}_{TC} , & {p}_{i} ∈ \{ 1001 , 1005 \} \\ {\overline{k}}_{TC} , & otherwise\end{matrix} , \qquad ( a )$$

where transmission comb offset k̅_{TC}∈{0, 1, . . . , K_{TC}−1} is contained in the higher-layer parameter transmissionComb for K_{TC}≥4, and RPFS offset n_{offset}^{RPFS} is given by

$${n}_{offset}^{RPFS} = \{ \begin{matrix}{N}_{sc}^{RB} {m}_{SRS , {B}_{SRS}} ( ( {k}_{F} + {k}_{hop} ) mod {P}_{F} ) / {P}_{F} , & {p}_{i} ∈ \{ 1000 , 1001 , 1002 , 1003 \} \\ {N}_{sc}^{RB} {m}_{SRS , {B}_{SRS}} ( ( {k}_{F} + {P}_{F} / 2 + {k}_{hop} ) mod {P}_{F} ) / {P}_{F} , & {p}_{i} ∈ \{ 1004 , 1005 , 1006 , 1007 \}\end{matrix} \qquad ( b )$$

where the parameters in (b) are described in Section 6.4.1.4.3 in [6] and P_{F}≥2. As seen in (a), k_{TC}^{(p}^{ᵢ}⁾ is the same for pᵢ∈{1000, 1004}, pᵢ∈{1001, 1005}, pᵢ∈{1002, 1006}, and pᵢ∈{1003, 1007}, respectively. In other words, each of the antenna ports of {1000, 1001, 1002, 1003} is associated with a different transmission comb offset (Group 1) and each of the antenna ports of {1004, 1005, 1006, 1007} is associated with a different transmission comb offset (Group 2). For the two groups, a same set of transmission comb offsets is used. As seen in (b), Group 1 of {1000, 1001, 1002, 1003} is associated with n_{offset}^{RPFS}=N_{sc}^{RB} m_{SRS,B}_{_{SRS}} ((k_{F}+kₕₒₚ) mod P_{F})/P_{F} and Group 2 of {1004, 1005, 1006, 1007} is associated with n_{offset}^{RPFS}=N_{sc}^{RB} m_{SRS,B}_{_{SRS}} ((k_{F}+P_{F}/2+kₕₒₚ) mod P_{F})/P_{F}. That is, different RPFS offset values are associated with the two groups.

In another example, antenna port numbers associated with groups can be different in the above example, e.g., Group 1={1000, 1002, 1004, 1006} and Group 2={1001, 1003, 1005, 1007}.

In one example, the 8 antenna ports are partitioned into two groups each of which is associated with 4 antenna ports. Within each group, each antenna port is associated with a different transmission comb offset k_{TC}^{(p}^{ᵢ}⁾. Each group is associated with a different RPFS offset n_{offset}^{RPFS}, and a different set of transmission comb offsets.

In one example, when Nₐₚ^{SRS}=8, transmission comb offset k_{TC}^{(p}^{ᵢ}⁾ is given by

k_{TC}^{(p}^{ᵢ}⁾={(k̅_{TC}+K_{TC}(pᵢ−1000)/8)mod K_{TC} (c),

where transmission comb offset k̅_{TC}∈{0, 1, . . . , K_{TC}−1} is contained in the higher-layer parameter transmissionComb for K_{TC}≥8, and RPFS offset n_{offset}^{RPFS} is given by

$${n}_{offset}^{RPFS} = \{ \begin{matrix}{N}_{sc}^{RB} {m}_{SRS , {B}_{SRS}} ( ( {k}_{F} + {k}_{hop} ) mod {P}_{F} ) / {P}_{F} , & {p}_{i} ∈ \{ 1000 , 1001 , 1002 , 1003 \} \\ {N}_{sc}^{RB} {m}_{SRS , {B}_{SRS}} ( ( {k}_{F} + {P}_{F} / 2 + {k}_{hop} ) mod {P}_{F} ) / {P}_{F} , & {p}_{i} ∈ \{ 1004 , 1005 , 1006 , 1007 \}\end{matrix} \qquad ( d )$$

where the parameters in (b) are described in Section 6.4.1.4.3 in [6] and P_{F}≥2. As seen in (c), k_{TC}^{(p}^{ᵢ}⁾ is different for pᵢ∈{1000, 1001, . . . , 1007}. In other words, each of the antenna ports of {1000, 1001, 1002, 1003} is associated with a different transmission comb offset (Group 1) and each of the antenna ports of {1004, 1005, 1006, 1007} is associated with a different transmission comb offset (Group 2). For the two groups, two different sets of transmission comb offsets are used. As seen in (d), Group 1 of {1000, 1001, 1002, 1003} is associated with n_{offset}^{RPFS}=N_{sc}^{RB} m_{SRS,B}_{_{SRS}} ((k_{F}+kₕₒₚ) mod P_{F})/P_{F} and Group 2 of {1004, 1005, 1006, 1007} is associated with n_{offset}^{RPFS}=N_{sc}^{RB} m_{SRS,B}_{_{SRS}} ((k_{F}P_{F}/2+kₕₒₚ) mod P_{F})/P_{F}. Hop That is, different RPFS offset values are associated with the two groups.

In another example, antenna port numbers associated with groups can be different in the above example, e.g., Group 1={1000, 1002, 1004, 1006} and Group 2={1001, 1003, 1005, 1007}.

In one example, the 8 antenna ports are partitioned into two groups each of which is associated with 4 antenna ports. Within each group, each antenna port is associated with a different RPFS offset n_{offset}^{RPFS}. Each group is associated with a different transmission comb offset k_{TC}^{(p}^{ᵢ}⁾, and a same set of RPFS offsets.

In one example, when Nₐₚ^{SRS}=8, transmission comb offset k_{TC}^{(p}^{ᵢ}⁾ is given by

$${k}_{TC}^{( {p}_{i} )} = \{ \begin{matrix}( {\overline{k}}_{TC} + {K}_{TC} / 2 ) mod {K}_{TC} , & {p}_{i} ∈ \{ 1001 , 1003 , 1005 , 1007 \} \\ {\overline{k}}_{TC} , & otherwise\end{matrix} , \qquad ( e )$$

where transmission comb offset k̅_{TC}∈{0, 1, . . . , K_{TC}−1} is contained in the higher-layer parameter transmissionComb for K_{TC}≥2, and RPFS offset n_{offset}^{RPFS} is given by

$${n}_{offset}^{RPFS} = \{ {N}_{sc}^{RB} {m}_{SRS , {B}_{SRS}} ( ( {k}_{F} + \frac{{P}_{F} ⌊ ( {p}_{i} - 1000 ) / 2 ⌋}{4} + {k}_{hop} ) mod {P}_{F} ) / {P}_{F} \qquad ( f )$$

where the parameters in (b) are described in Section 6.4.1.4.3 in [6] and P_{F}≥4. As seen in (f), n_{offset}^{RPFS} is the same for pᵢ∈{1000, 1001}, pᵢ∈{1002, 1003}, pᵢ∈{1004, 1005}, and pᵢ∈{1006, 1007}, respectively. In other words, each of the antenna ports of {1000, 1002, 1004, 1006} is associated with a RPFS offset (Group 1) and each of the antenna ports of {1001, 1003, 1005, 1007} is associated with a RPFS offset (Group 2). For the two groups, a same set of RPFS offsets is used. As seen in (e), Group 1 of {1000, 1002, 1004, 1006} is associated with k_{TC}^{(p}^{ᵢ}⁾=k̅_{TC} and Group 2 of {1001, 1003, 1005, 1007} is associated with k_{TC}^{(p}^{ᵢ}⁾=(k̅_{TC}+K_{TC}/2) mod K_{TC}. That is, different transmission comb values are associated with the two groups.

In another example, antenna port numbers associated with groups can be different in the above example, e.g., Group 1={1000, 1001, 1002, 1003} and Group 2={1004, 1005, 1006, 1007}.

In one example, the 8 antenna ports are partitioned into two groups each of which is associated with 4 antenna ports. Within each group, each antenna port is associated with a different RPFS offset n_{offset}^{RPFS}. Each group is associated with a different transmission comb offset k_{TC}^{(p}^{ᵢ}⁾ and a different set of RPFS offsets.

In one example, when Nₐₚ^{SRS}=8, transmission comb offset k_{TC}^{(p}^{ᵢ}⁾ is given by

$${k}_{TC}^{( {p}_{i} )} = \{ \begin{matrix}( {\overline{k}}_{TC} + {K}_{TC} / 2 ) mod {K}_{TC} , & {p}_{i} ∈ \{ 1001 , 1003 , 1005 , 1007 \} \\ {\overline{k}}_{TC} , & otherwise\end{matrix} , \qquad ( g )$$

where transmission comb offset k̅_{TC}∈{0, 1, . . . , K_{TC}−1} is contained in the higher-layer parameter transmissionComb for K_{TC}≥2, and RPFS offset n_{offset}^{RPFS} is given by

$${n}_{offset}^{RPFS} = \{ {N}_{sc}^{RB} {m}_{SRS , {B}_{SRS}} ( ( {k}_{F} + \frac{{P}_{F} ( {p}_{i} - 1000 )}{8} + {k}_{hop} ) mod {P}_{F} ) / {P}_{F} \qquad ( h )$$

where the parameters in (b) are described in Section 6.4.1.4.3 in [6] and P_{F}≥8 (if specified). As seen in (h), n_{offset}^{RPFS} is different for pᵢ∈{1000, 1001, . . . , 1007}. In other words, each of the antenna ports of {1000, 1002, 1004, 1006} is associated with a RPFS offset (Group 1) and each of the antenna ports of {1001, 1003, 1005, 1007} is associated with a RPFS offset (Group 2). For the two groups, two different sets of RPFS offsets are used. As seen in (g), Group 1 of {1000, 1002, 1004, 1006} is associated with k_{TC}^{(p}^{ᵢ}⁾=k̅_{TC} and Group 2 of {1001, 1003, 1005, 1007} is associated with k_{TC}^{(p}^{ᵢ}⁾=(k̅_{TC}+K_{TC}/2) mod K_{TC}. That is, different transmission comb values are associated with the two groups.

In another example, antenna port numbers associated with groups can be different in the above example, e.g., Group 1={1000, 1001, 1002, 1003} and Group 2={1004, 1005, 1006, 1007}.

In one example, the 8 antenna ports are partitioned into 4 groups each of which is associated with 2 antenna ports. Within each group, each antenna port is associated with a different transmission comb offset k_{TC}^{(p}^{ᵢ}⁾. Each group is associated with a different RPFS offset n_{offset}^{RPFS}, and a same set of transmission comb offsets.

In one example, the 8 antenna ports are partitioned into 4 groups each of which is associated with 2 antenna ports. Within each group, each antenna port is associated with a different transmission comb offset k_{TC}^{(p}^{ᵢ}⁾. Each group is associated with a different RPFS offset n_{offset}^{RPFS}, and a different set of transmission comb offsets.

In one example, the 8 antenna ports are partitioned into 4 groups each of which is associated with 2 antenna ports. Within each group, each antenna port is associated with a different RPFS offset n_{offset}^{RPFS}. Each group is associated with a different transmission comb offset k_{TC}^{(p}^{ᵢ}⁾, and a same set of RPFS offsets.

In one example, the 8 antenna ports are partitioned into 4 groups each of which is associated with 2 antenna ports. Within each group, each antenna port is associated with a different RPFS offset n_{offset}^{RPFS}. Each group is associated with a different transmission comb offset k_{TC}^{(p}^{ᵢ}⁾, and a different set of RPFS offsets.

In one embodiment, the sounding reference signal sequence for an SRS resource with 8 ports is generated using a CD component to multiplex the SRS resource across ports.

In one embodiment, the SRS sequence is generated using different cyclic shifts (αᵢ of Section 6.4.1.4.2 in [6]) across 8 antenna ports.

In one example, when n_{SRS}^{cs,max}=8, where n_{SRS}^{cs,max} is a maximum number of cyclic shifts (Section 6.4.1.4.2 in [6]), the SRS sequence for an antenna port is generated based on its associated cyclic shift. For example, as in Section 6.4.1.4.2 in [6], a cyclic shift αᵢ is computed as

$${α}_{i} = 2 π \frac{{n}_{SRS}^{cs , i}}{{n}_{SRS}^{cs , max}} ,$$

where

$${n}_{SRS}^{cs , i} = ( {n}_{SRS}^{cs} + \frac{{n}_{SRS}^{cs , max} ( {p}_{i} - 1000 )}{{N}_{ap}^{SRS}} ) mod {n}_{SRS}^{cs , max} ,$$

antenna ports

$${\{ {p}_{i} \}}_{i = 0}^{{N}_{ap}^{SRS} - 1} ,$$

pᵢ=1000+i, and n_{SRS}^{cs}={0, 1, . . . , n_{SRS}^{cs,max}−1} that is contained in the higher-layer parameter transmissionComb.

In one example, when n_{SRS}^{cs,max}≥8, the SRS sequence for an antenna port is generated based on its associated cyclic shift.

In one example, a cyclic shift αᵢ is computed as

$${α}_{i} = 2 π \frac{{n}_{SRS}^{cs , i}}{{n}_{SRS}^{cs , max}} ,$$

where

$${n}_{SRS}^{cs , i} = ( {n}_{SRS}^{cs} + ⌊ \frac{{n}_{SRS}^{cs , max} ( {p}_{i} - 1000 )}{{N}_{ap}^{SRS}} ⌋ ) mod {n}_{SRS}^{cs , max} ,$$

where antenna ports

$${\{ {p}_{i} \}}_{i = 0}^{{N}_{ap}^{SRS} - 1} ,$$

pᵢ=1000+i, and n_{SRS}^{cs}={0, 1, . . . , n_{SRS}^{cs,max}−1} that is contained in the higher-layer parameter transmissionComb.

In one embodiment, the sounding reference signal sequence for an SRS resource with 8 ports is generated using FD and CD components to multiplex the SRS resource across antenna ports.

In one embodiment, the SRS sequence is generated using (different) combination of transmission comb offsets and cyclic shifts (k_{TC}^{(p}^{ᵢ}⁾ and αᵢ of Sections 6.4.1.4.2 and 6.4.1.4.3 in [6]) across 8 antenna ports. For example, a different pair of (k_{TC}^{(p}^{ᵢ}⁾, αᵢ) for generating the SRS sequence is associated with an antenna port.

In one example, the 8 antenna ports are partitioned into two groups each of which is associated with 4 antenna ports. Within each group, each antenna port is associated with a different cyclic shift αᵢ. Each group is associated with a different transmission comb offset k_{TC}^{(p}^{ᵢ}⁾, and a same set of cyclic shifts.

In one example, cyclic shift αᵢ is computed as

$${α}_{i} = 2 π \frac{{n}_{SRS}^{cs , i}}{{n}_{SRS}^{cs , max}} ,$$

where

$${n}_{SRS}^{cs , i} = ( {n}_{SRS}^{cs} + \frac{{n}_{SRS}^{cs , max} ⌊ ( {p}_{i} - 1000 ) / 2 ⌋}{{N}_{ap}^{SRS} / 2} ) mod {n}_{SRS}^{cs , max} . \qquad ( 1 )$$

antenna ports

$${\{ {p}_{i} \}}_{i = 0}^{{N}_{ap}^{SRS} - 1} ,$$

pᵢ=1000+i, and n_{SRS}^{cs}={0, 1, . . . , n_{SRS}^{cs,max}−1} that is contained in the higher-layer parameter transmissionComb, and

$${k}_{TC}^{( {p}_{i} )} = \{ \begin{matrix}( {\overline{k}}_{TC} + {K}_{TC} / 2 ) mod {K}_{TC} & if {N}_{ap}^{SRS} = 8 , {p}_{i} ∈ \{ 1001 , 1003 , 1005 , 1007 \} \\ {\overline{k}}_{TC} & otherwise\end{matrix} , \qquad ( 2 )$$

where transmission comb offset k̅_{TC}∈{0, 1, . . . , K_{TC}−1} is contained in the higher-layer parameter transmissionComb. In this case, as seen in (1) αᵢ is the same for pᵢ∈{1000, 1001}, pᵢ∈{1002, 1003}, pᵢ∈{1004, 1005}, and pᵢ∈{1006, 1007}, respectively. In other words, each of the antenna ports of {1000, 1002, 1004, 1006} is associated with a different cyclic shift (Group 1) and each of the antenna ports of {1001, 1003, 1005, 1007} is associated with a different cyclic shift (Group 2). For the two groups, a same set of cyclic shifts is used. As seen in (2), Group 1 of {1000, 1002, 1004, 1006} is associated with k_{TC}^{(p}^{ᵢ}⁾=k̅_{TC} and Group 2 of {1001, 1003, 1005, 1007} is associated with k_{TC}^{(p}^{ᵢ}⁾=(k̅_{TC}+K_{TC}/2) mod K_{TC}.

In another example, antenna port numbers associated with groups can be different in the above example, e.g., Group 1={1000, 1001, 1002, 1003} and Group 2={1004, 1005, 1006, 1007}.

In one example, the 8 antenna ports are partitioned into two groups each of which is associated with 4 ports. Within each group, each antenna port is associated with a different cyclic shift αᵢ. Each group is associated with a different transmission comb offset k_{TC}^{(p}^{ᵢ}⁾, and a different set of cyclic shifts.

In one example, cyclic shift αᵢ is computed as

$${α}_{i} = 2 π \frac{{n}_{SRS}^{cs , i}}{{n}_{SRS}^{cs , max}} ,$$

where

$${n}_{SRS}^{cs , i} = ( {n}_{SRS}^{cs} + \frac{{n}_{SRS}^{cs , max} ( {p}_{i} - 1000 )}{{N}_{ap}^{SRS}} ) mod {n}_{SRS}^{cs , max} . \qquad ( 3 )$$

antenna ports

$${\{ {p}_{i} \}}_{i = 0}^{{N}_{ap}^{SRS} - 1} ,$$

pᵢ=1000+i, and n_{SRS}^{cs}={0, 1, . . . , n_{SRS}^{cs,max}−1} that is contained in the higher-layer parameter transmissionComb, and

$${k}_{TC}^{( {p}_{i} )} = \{ \begin{matrix}( {\overline{k}}_{TC} + {K}_{TC} / 2 ) mod {K}_{TC} & if {N}_{ap}^{SRS} = 8 , {p}_{i} ∈ \{ 1001 , 1003 , 1005 , 1007 \} \\ {\overline{k}}_{TC} & otherwise\end{matrix} , \qquad ( 4 )$$

where transmission comb offset k̅_{TC}∈{0, 1, . . . , K_{TC}−1} is contained in the higher-layer parameter transmissionComb. In this case, as seen in (3) αᵢ is different for pᵢ∈{1000, 1001, 1002, . . . , 1007}. In other words, each of the antenna ports of {1000, 1002, 1004, 1006} is associated with a different cyclic shift (Group 1) and each of the antenna ports of {1001, 1003, 1005, 1007} is associated with a different cyclic shift (Group 2). For the two groups, two different sets of cyclic shifts are used. As seen in (4), Group 1 of {1000, 1002, 1004, 1006} is associated with k_{TC}^{(p}^{ᵢ}⁾=k̅_{TC} and Group 2 of {1001, 1003, 1005, 1007} is associated with k_{TC}^{(p}^{ᵢ}⁾=(k̅_{TC}+K_{TC}/2) mod K_{TC}.

In another example, antenna port numbers associated with groups can be different in the above example, e.g., Group 1={1000, 1001, 1002, 1003} and Group 2={1004, 1005, 1006, 1007}.

In one example, the 8 antenna ports are partitioned into two groups each of which is associated with 4 ports. Within each group, each antenna port is associated with a different transmission comb offset k_{TC}^{(p}^{ᵢ}⁾. Each group is associated with a different cyclic shift αᵢ, and a same set of transmission comb offsets.

In one example, cyclic shift αᵢ is computed as

$${α}_{i} = 2 π \frac{{n}_{SRS}^{cs , i}}{{n}_{SRS}^{cs , max}} ,$$

where

$${n}_{SRS}^{cs , i} = ( {n}_{SRS}^{cs} + \frac{{n}_{SRS}^{cs , max} ⌊ ( {p}_{i} - 1000 ) / 4 ⌋}{{N}_{ap}^{SRS} / 4} ) mod {n}_{SRS}^{cs , max} . \qquad ( 5 )$$

antenna ports

$${\{ {p}_{i} \}}_{i = 0}^{{N}_{ap}^{SRS} - 1} ,$$

pᵢ=1000+i, and n_{SRS}^{cs}={0, 1, . . . , n_{SRS}^{cs,max}−1} that is contained in the higher-layer parameter transmissionComb, and

$${k}_{TC}^{( {p}_{i} )} = \{ \begin{matrix}( {\overline{k}}_{TC} + 3 {K}_{TC} / 4 ) mod {K}_{TC} & if {N}_{ap}^{SRS} = 8 , {p}_{i} ∈ \{ 1003 , 1007 \} \\ ( {\overline{k}}_{TC} + {K}_{TC} / 2 ) mod {K}_{TC} & if {N}_{ap}^{SRS} = 8 , {p}_{i} ∈ \{ 1002 , 1006 \} \\ ( {\overline{k}}_{TC} + {K}_{TC} / 4 ) mod {K}_{TC} & if {N}_{ap}^{SRS} = 8 , {p}_{i} ∈ \{ 1001 , 1005 \} \\ {\overline{k}}_{TC} & otherwise\end{matrix} , \qquad ( 6 )$$

where transmission comb offset k̅_{TC}∈{0, 1, . . . , K_{TC}−1} is contained in the higher-layer parameter transmissionComb, K_{TC}≥4. In this case, as seen in (5) αᵢ is the same for pᵢ∈{1000, 1001, 1002, 1003}, (Group 1) and pᵢ∈{1004, 1005, 1006, 1007}, (Group 2) respectively. In other words, each group is associated with a different cyclic shift αᵢ. As seen in (6), within each group, each antenna port is associated with a different transmission comb offset k_{TC}^{(p}^{ᵢ}⁾. For the two groups, a same set of transmission comb offsets is used.

In another example, antenna port numbers associated with groups can be different in the above example, e.g., Group 1={1000, 1002, 1004, 1006} and Group 2={1001, 1003, 1005, 1007}.

In one example, the 8 antenna ports are partitioned into two groups each of which is associated with 4 ports. Within each group, each antenna port is associated with a different transmission comb offset k_{TC}^{(p}^{ᵢ}⁾. Each group is associated with a different cyclic shift αᵢ, and a different set of transmission comb offsets.

In one example, cyclic shift αᵢ is computed as

$${α}_{i} = 2 π \frac{{n}_{SRS}^{cs , i}}{{n}_{SRS}^{cs , max}} ,$$

where

$${n}_{SRS}^{cs , i} = ( {n}_{SRS}^{cs} + \frac{{n}_{SRS}^{cs , max} ⌊ ( {p}_{i} - 1000 ) / 4 ⌋}{{N}_{ap}^{SRS} / 4} ) mod {n}_{SRS}^{cs , max} . \qquad ( 7 )$$

antenna ports

$${\{ {p}_{i} \}}_{i = 0}^{{N}_{ap}^{SRS} - 1} ,$$

pᵢ=1000+i, and n_{SRS}^{cs}={0, 1, . . . , n_{SRS}^{cs,max}−1} that is contained in the higher-layer parameter transmissionComb, and

k_{TC}^{(p}^{ᵢ}⁾={(k̅_{TC}+K_{TC}(pᵢ−1000)/8)mod K_{TC} if Nₐₚ^{SRS}=8 (8),

where transmission comb offset k̅_{TC}∈{0, 1, . . . , K_{TC}−1} is contained in the higher-layer parameter transmissionComb, K_{TC}≥8. In this case, as seen in (7) αᵢ is the same for pᵢ∈{1000, 1001, 1002, 1003}, (Group 1) and pᵢ∈{1004, 1005, 1006, 1007}, (Group 2) respectively. In other words, each group is associated with a different cyclic shift αᵢ. As seen in (8), within each group, each antenna port is associated with a different transmission comb offset k_{TC}^{(p}^{ᵢ}⁾. For the two groups, two different sets of transmission comb offsets are used.

In another example, antenna port numbers associated with groups can be different in the above example, e.g., Group 1={1000, 1002, 1004, 1006} and Group 2={1001, 1003, 1005, 1007}.

In one example, the 8 antenna ports are partitioned into 4 groups each of which is associated with 2 antenna ports. Within each group, each antenna port is associated with a different cyclic shift αᵢ. Each group is associated with a different transmission comb offset k_{TC}^{(p}^{ᵢ}⁾, and a same set of cyclic shifts.

In one example, the 8 antenna ports are partitioned into 4 groups each of which is associated with 2 antenna ports. Within each group, each antenna port is associated with a different cyclic shift αᵢ. Each group is associated with a different transmission comb offset k_{TC}^{(p}^{ᵢ}⁾, and a different set of cyclic shifts.

In one example, the 8 antenna ports are partitioned into 4 groups each of which is associated with 2 ports. Within each group, each antenna port is associated with a different transmission comb offset k_{TC}^{(p}^{ᵢ}⁾. Each group is associated with a different cyclic shift αᵢ, and a same set of transmission comb offsets.

In one example, the 8 antenna ports are partitioned into 4 groups each of which is associated with 2 ports. Within each group, each antenna port is associated with a different transmission comb offset k_{TC}^{(p}^{ᵢ}⁾. Each group is associated with a different cyclic shift αᵢ, and a different set of transmission comb offsets.

In one embodiment, the SRS sequence is generated using (different) combination of cyclic shifts and RPFS offsets (αᵢ and n_{offset}^{RPFS} of Sections 6.4.1.4.2 and 6.4.1.4.3 in [6]) across 8 antenna ports.

In one example, the 8 antenna ports are partitioned into two groups each of which is associated with 4 antenna ports. Within each group, each antenna port is associated with a different cyclic shift αᵢ. Each group is associated with a different RPFS offset n_{offset}^{RPFS}, and a same set of cyclic shifts.

In one example, the 8 antenna ports are partitioned into two groups each of which is associated with 4 antenna ports. Within each group, each antenna port is associated with a different cyclic shift αᵢ. Each group is associated with a different RPFS offset n_{offset}^{RPFS}, and a different set of cyclic shifts.

In one example, the 8 antenna ports are partitioned into two groups each of which is associated with 4 ports. Within each group, each antenna port is associated with a different RPFS offset n_{offset}^{RPFS}. Each group is associated with a different cyclic shift αᵢ, and a same set of RPFS offsets.

In one example, the 8 antenna ports are partitioned into two groups each of which is associated with 4 ports. Within each group, each antenna port is associated with a different RPFS offset n_{offset}^{RPFS}. Each group is associated with a different cyclic shift αᵢ, and a different set of RPFS offsets.

In one example, the 8 antenna ports are partitioned into 4 groups each of which is associated with 2 antenna ports. Within each group, each antenna port is associated with a different cyclic shift αᵢ. Each group is associated with a different RPFS offset n_{offset}^{RPFS}, and a same set of cyclic shifts.

In one example, the 8 antenna ports are partitioned into 4 groups each of which is associated with 2 antenna ports. Within each group, each antenna port is associated with a different cyclic shift αᵢ. Each group is associated with a different RPFS offset n_{offset}^{RPFS}, and a different set of cyclic shifts.

In one example, the 8 antenna ports are partitioned into 4 groups each of which is associated with 2 ports. Within each group, each antenna port is associated with a different RPFS offset n_{offset}^{RPFS}. Each group is associated with a different cyclic shift αᵢ, and a same set of RPFS offsets.

In one example, the 8 antenna ports are partitioned into 4 groups each of which is associated with 2 ports. Within each group, each antenna port is associated with a different RPFS offset n_{offset}^{RPFS}. Each group is associated with a different cyclic shift αᵢ, and a different set of RPFS offsets.

In one embodiment, the SRS sequence is generated using (different) combination of cyclic shifts, transmission comb offsets, and RPFS offsets (αᵢ, k_{TC}^{(p}^{ᵢ}⁾, and n_{offset}^{RPFS} of Sections 6.4.1.4.2 and 6.4.1.4.3 in [6]) across 8 antenna ports.

In one example, the 8 antenna ports are partitioned into two groups each of which is associated with 4 antenna ports. Two different transmission comb offsets are associated with two groups. Within each of the two groups, the 4 antenna ports are further partitioned into two sub-groups each of which is associated with 2 antenna ports. Two different cyclic shifts are associated with the two sub-groups for each group. Two different RPFS offsets are associated with the two antenna ports in each sub-group.

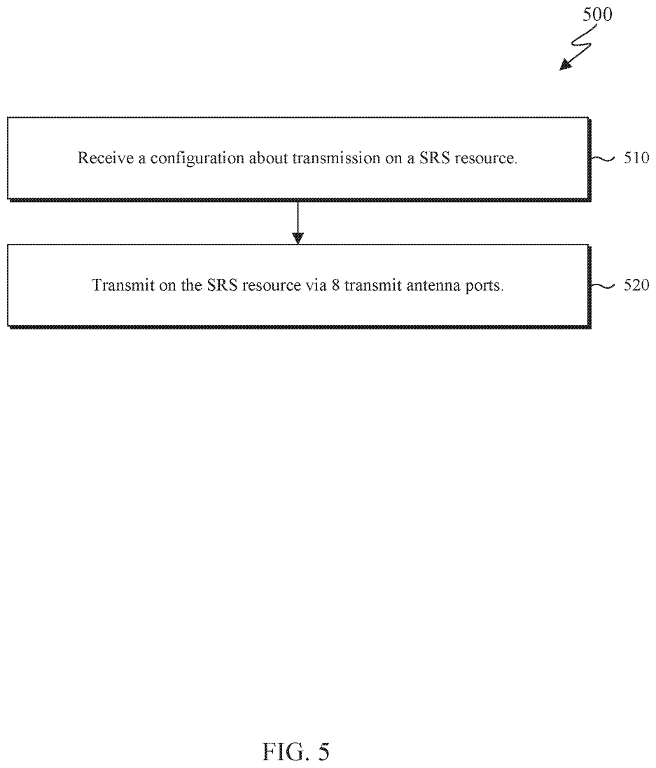

FIG. 5 illustrates a flowchart of an example method 500 for SRS procedures in a wireless communication system according to embodiments of the present disclosure. The steps of the method 500 of FIG. 5 can be performed by any of the UEs 111-116 of FIG. 1, such as the UE 116 of FIG. 3 and a corresponding method may be performed by a base station, such as gNBs 101-103. The method 500 is for illustration only and other embodiments can be used without departing from the scope of the present disclosure.

The method 500 begins with the UE receiving a configuration about transmission on a SRS resource (block 510). For example, in block 510, the configuration includes information about 8 transmit antenna ports partitioned into X antenna groups. Here, each of the X antenna groups includes respective 8/X antenna ports. In one embodiment, each of the X antenna groups is associated with a respective transmission comb offset and each of the respective 8/X antenna ports within a group of the X antenna groups is associated with a respective cyclic shift. In another embodiment, each of the X antenna groups is associated with a respective cyclic shift and each of the respective 8/X antenna ports within the group of the X antenna groups is associated with a respective transmission comb offset.

The UE then transmits on the SRS resource via the 8 transmit antenna ports (block 520). For example, in block 520, the UE transmits the SRS transmission based on the configuration including using the associated transmission comb offset and cyclic shift parameters for the associated antenna port groups.

In one or more of the above embodiments, X=2 and a maximum number of cyclic shifts=8, each of the X antenna groups is associated with a respective transmission comb offset k_{TC}^{(p}^{ᵢ}⁾ and a same set of cyclic shifts, and within each of the X antenna groups, each antenna port is associated with a respective cyclic shift αᵢ.

In one or more of the above embodiments, X=2 and a maximum number of cyclic shifts=12, each of the X antenna groups is associated with a respective transmission comb offset k_{TC}^{(p}^{ᵢ}⁾ and a different set of cyclic shifts, and within each of the X antenna groups, each antenna port is associated with a respective cyclic shift αᵢ.

In one or more of the above embodiments, X=2 and a maximum number of cyclic shifts=6, each of the X antenna groups is associated with a respective cyclic shift αᵢ and a same set of transmission comb offsets, and within each of the X antenna groups, each antenna port is associated with a respective transmission comb offset k_{TC}^{(p}^{ᵢ}⁾.

In one or more of the above embodiments, X=4 and a maximum number of cyclic shifts=12, each of the X antenna groups is associated with a respective transmission comb offset k_{TC}^{(p}^{ᵢ}⁾ and a same set of the cyclic shifts, and within each of the X antenna groups, each antenna port is associated with a respective cyclic shift αᵢ.

In one or more of the above embodiments, X=4 and a maximum number of cyclic shifts=6, each of the X antenna groups is associated with a respective transmission comb offset k_{TC}^{(p}^{ᵢ}⁾ and a respective set of cyclic shifts, and within each of the X antenna groups, each antenna port is associated with a respective cyclic shift αᵢ.

In one or more of the above embodiments, X=4 and a maximum number of cyclic shifts=12, each of the X antenna groups is associated with a respective cyclic shift αᵢ and a same set of transmission comb offsets, and within each of the X antenna groups, each antenna port is associated with a respective transmission comb offset k_{TC}^{(p}^{ᵢ}⁾.

In one or more of the above embodiments, X=8 and a maximum number of cyclic shifts=8 and within each of the X antenna groups, each antenna port is associated with a respective cyclic shift αᵢ and a same transmission offset k_{TC}^{(p}^{ᵢ}⁾.

Any of the above variation embodiments can be utilized independently or in combination with at least one other variation embodiment.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive a configuration about transmission on a sounding reference signal (SRS) resource; and
a processor operably coupled to the transceiver, the processor configured to identify, based on the configuration, information about 8 transmit antenna ports partitioned into X antenna groups,
wherein each of the X antenna groups includes respective 8/X antenna ports,
wherein:
each of the X antenna groups is associated with a respective transmission comb offset and each of the respective 8/X antenna ports within a group of the X antenna groups is associated with a respective cyclic shift, or
each of the X antenna groups is associated with a respective cyclic shift and each of the respective 8/X antenna ports within the group of the X antenna groups is associated with a respective transmission comb offset, and
wherein the transceiver is further configured to transmit, based on the configuration, on the SRS resource via the 8 transmit antenna ports.

2. The UE of claim 1, wherein:
X=2 and a maximum number of cyclic shifts=8,
each of the X antenna groups is associated with a respective transmission comb offset k_{TC}^{(p}^{ᵢ}⁾ and a same set of cyclic shifts, and
within each of the X antenna groups, each antenna port is associated with a respective cyclic shift αᵢ.

3. The UE of claim 1, wherein:
X=2 and a maximum number of cyclic shifts=12,
each of the X antenna groups is associated with a respective transmission comb offset k_{TC}^{(p}^{ᵢ}⁾ and a different set of cyclic shifts, and
within each of the X antenna groups, each antenna port is associated with a respective cyclic shift αᵢ.

4. The UE of claim 1, wherein:
X=2 and a maximum number of cyclic shifts=6,
each of the X antenna groups is associated with a respective cyclic shift αᵢ and a same set of transmission comb offsets, and
within each of the X antenna groups, each antenna port is associated with a respective transmission comb offset k_{TC}^{(p}^{ᵢ}⁾.

5. The UE of claim 1, wherein:
X=4 and a maximum number of cyclic shifts=12,
each of the X antenna groups is associated with a respective transmission comb offset k_{TC}^{(p}^{ᵢ}⁾ and a same set of the cyclic shifts, and
within each of the X antenna groups, each antenna port is associated with a respective cyclic shift αᵢ.

6. The UE of claim 1, wherein:
X=4 and a maximum number of cyclic shifts=6,
each of the X antenna groups is associated with a respective transmission comb offset k_{TC}^{(p}^{ᵢ}⁾ and a respective set of cyclic shifts, and
within each of the X antenna groups, each antenna port is associated with a respective cyclic shift αᵢ.

7. The UE of claim 1, wherein:
X=4 and a maximum number of cyclic shifts=12,
each of the X antenna groups is associated with a respective cyclic shift αᵢ and a same set of transmission comb offsets, and
within each of the X antenna groups, each antenna port is associated with a respective transmission comb offset k_{TC}^{(p}^{ᵢ}⁾.

8. The UE of claim 1, wherein:
X=8 and a maximum number of cyclic shifts=8, and
within each of the X antenna groups, each antenna port is associated with a respective cyclic shift αᵢ and a same transmission offset k_{TC}^{(p}^{ᵢ}⁾.

9. A base station (BS) comprising:
a processor configured to generate a configuration about transmission on a sounding reference signal (SRS) resource, wherein the configuration including information about 8 transmit antenna ports partitioned into X antenna groups, wherein each of the X antenna groups includes respective 8/X antenna ports, and wherein:
each of the X antenna groups is associated with a respective transmission comb offset and each of the respective 8/X antenna ports within a group of the X antenna groups is associated with a respective cyclic shift, or
each of the X antenna groups is associated with a respective cyclic shift and each of the respective 8/X antenna ports within the group of the X antenna groups is associated with a respective transmission comb offset; and
a transceiver operably coupled to the processor, the transceiver configured to:
transmit the configuration; and
receive, based on the configuration, on the SRS resource.

10. The BS of claim 9, wherein:
X=2 and a maximum number of cyclic shifts=8,
each of the X antenna groups is associated with a respective transmission comb offset k_{TC}^{(p}^{ᵢ}⁾ and a same set of cyclic shifts, and
within each of the X antenna groups, each antenna port is associated with a respective cyclic shift αᵢ.

11. The BS of claim 9, wherein:
X=2 and a maximum number of cyclic shifts=12,
each of the X antenna groups is associated with a respective transmission comb offset k_{TC}^{(p}^{ᵢ}⁾ and a different set of cyclic shifts, and
within each of the X antenna groups, each antenna port is associated with a respective cyclic shift αᵢ.

12. The BS of claim 9, wherein:
X=2 and a maximum number of cyclic shifts=6,
each of the X antenna groups is associated with a respective cyclic shift αᵢ and a same set of transmission comb offsets, and
within each of the X antenna groups, each antenna port is associated with a respective transmission comb offset k_{TC}^{(p}^{ᵢ}⁾.

13. The BS of claim 9, wherein:
X=4 and a maximum number of cyclic shifts=12,
each of the X antenna groups is associated with a respective transmission comb offset k_{TC}^{(p}^{ᵢ}⁾ and a same set of the cyclic shifts, and
within each of the X antenna groups, each antenna port is associated with a respective cyclic shift αᵢ.

14. The BS of claim 9, wherein:
X=4 and a maximum number of cyclic shifts=6,
each of the X antenna groups is associated with a respective transmission comb offset k_{TC}^{(p}^{ᵢ}⁾ and a respective set of cyclic shifts, and
within each of the X antenna groups, each antenna port is associated with a respective cyclic shift αᵢ.

15. The BS of claim 9, wherein:
X=4 and a maximum number of cyclic shifts=12,
each of the X antenna groups is associated with a respective cyclic shift αᵢ and a same set of transmission comb offsets, and
within each of the X antenna groups, each antenna port is associated with a respective transmission comb offset k_{TC}^{(p}^{ᵢ}⁾.

16. The BS of claim 9, wherein:
X=8 and a maximum number of cyclic shifts=8, and
within each of the X antenna groups, each antenna port is associated with a respective cyclic shift αᵢ and a same transmission offset k_{TC}^{(p}^{ᵢ}⁾.

17. A method performed by a user equipment (UE), the method comprising:
receiving a configuration about transmission on a sounding reference signal (SRS) resource, the configuration including information about 8 transmit antenna ports partitioned into X antenna groups, wherein each of the X antenna groups includes respective 8/X antenna ports and wherein:
each of the X antenna groups is associated with a respective transmission comb offset and each of the respective 8/X antenna ports within a group of the X antenna groups is associated with a respective cyclic shift, or
each of the X antenna groups is associated with a respective cyclic shift and each of the respective 8/X antenna ports within the group of the X antenna groups is associated with a respective transmission comb offset; and
transmitting, based on the configuration, on the SRS resource via the 8 transmit antenna ports.

18. The method of claim 17, wherein:
X=2 and a maximum number of cyclic shifts=8,
each of the X antenna groups is associated with a respective transmission comb offset k_{TC}^{(p}^{ᵢ}⁾ and a same set of cyclic shifts, and
within each of the X antenna groups, each antenna port is associated with a respective cyclic shift αᵢ.

19. The method of claim 17, wherein:
X=2 and a maximum number of cyclic shifts=12,
each of the X antenna groups is associated with a respective transmission comb offset k_{TC}^{(p}^{ᵢ}⁾ and a different set of cyclic shifts, and
within each of the X antenna groups, each antenna port is associated with a respective cyclic shift αᵢ.

20. The method of claim 17, wherein:
X=2 and a maximum number of cyclic shifts=6,
each of the X antenna groups is associated with a respective cyclic shift αᵢ and a same set of transmission comb offsets, and
within each of the X antenna groups, each antenna port is associated with a respective transmission comb offset k_{TC}^{(p}^{ᵢ}⁾.
